(19) United States
(12) Patent Application Publication
(10) Pub. No.: US 2024/0369819 A1
(43) Pub. Date: Nov. 7, 2024

(54) Surgical Microscope Beam Splitter System

(71) Applicant: Jonathan M. Butler, Gainesville, GA (US)

(72) Inventor: Jonathan M. Butler, Gainesville, GA (US)

(21) Appl. No.: 18/653,315

(22) Filed: May 2, 2024

Related U.S. Application Data
(60) Provisional application No. 63/464,065, filed on May 4, 2023.

(51) Int. Cl. G02B 21/36; G02B 27/10; G02B 27/14

(52) U.S. Cl. CPC G02B 21/361; G02B 27/106; G02B 27/14

(57) ABSTRACT

A beam splitter configured to be mounted to a conventional ocular module and a conventional microscope module. The beam splitter further including at least one mirror assembly having a mirror armature and a mirror. Each mirror armature being positioned within the interior cavity of the housing and extends inwardly into a respective optical pathway such that the distal end of the armature is positioned proximate an optical pathway longitudinal axis. A bottom surface of the mirror can be mounted to the distal end of the mirror armature such that a reflective surface of the mirror is oriented at a 45 degree angle with respect to the optical pathway longitudinal axis.

### CROSS-REFERENCE

The present patent application claims benefit of U.S. Provisional Patent Application No. 63/464,065, filed May 4, 2023.

### INCORPORATED BY REFERENCE

The disclosure of U.S. Provisional Patent Application No. 63/464,065, filed May 4, 2023 is specifically incorporated by reference herein as if set forth in its entirety.

### TECHNICAL FIELD

The present disclosure relates generally to systems, apparatus and methods in the field of light beam splitting, more particularly, to various aspects involving systems and methods for an improved light beam splitting system for use in surgical microscopes.

### BACKGROUND

Within the industry of surgical and laboratory binocular or stereo microscopes, it is common practice to add a video or still image camera to a microscope system to allows a user to record video or images for later use for medical records or general documentation, presentations, etc. However, it is also commonly used as an aid during surgical procedures to allow others visual access to the surgical case. For example, many times nursing and O.R. staff will glance at a live image feed on the wall to see what point the surgeon is at during the case. This lets them know if he is almost done and time to prep the next patient. Some surgical centers also allow for family or medical students to view live cases on a video monitor outside of the actual operating room.

The industry standard way to do this is to add a modular beam splitter device between the microscope body and the viewing oculars. Conventionally, a microscope is configured to receives a light beam from a target to yield an image of the target. In certain microscopes, the use of at least one beam splitter allows the light beam to be split or combined with other light beams. For example, the light beam may be split to yield split beams that can then be sent to different destinations for different uses. e.g., to one or more eye pieces for viewing by one or more users and/or to a camera for recording.

A conventional beam splitter has a cube beam splitter prism in the optical pathway, or a cube beam splitter prism being positioned in each the right and left optical pathways for a binocular microscope. The cube beam splitter prism allows for certain amount of light to pass through the prism and a certain amount to be redirected off at a desired angle, which is typically set at 90°. In operation, a portion of the light beam passes through the prism and travels on to the user for viewing, and a portion of the light beam is redirected to, for example, a conventional camera adapter lens system, and then on to the conventional camera sensor for imaging.

Problematically, anytime light travels through an interface or through a piece of glass, there is an increased likelihood of adding artifact and degrading the view of the user. Accumulations of dust and debris, aberrations, and distortions can all occur as a result of using one or more cube beam splitter prisms in a beam splitter. One specific aberration that can occurs with a cube beam splitter prism is astigmatism due to the typical 45º incidence of the beam splitter interface, which can result in degradation of the user's view.

An additional undesired side effect from using one or more cube beam splitter prisms in a beam splitter is the loss of transmitted light resulting from the use of the cube beam splitter prism. Depending on the brand and style of beam splitter and acknowledging the non-preventable light loss, most industry standard units using a cube beam splitter prism are annotated as either 50%/50% or 80%/20% unit. The 50%/50% or 80%/20% nomenclature means 50% of the light is transmitted through to the user and 50% of the light is redirected, or 80% passes through to the user and 20% redirected, respectively. Also, one will appreciate that because of slight variances between the two respective cube beam splitter prisms in a conventional beam splitter for a binocular view, one eye of a user might “see” more light than the other eye.

In view of the prior aft, there remains a need for a beam splitter system that improves surgical microscope systems.

### SUMMARY

To improve the state of the art, disclosed herein is a beam splitter system, and methods of use thereof, utilizing novel functionalities. The beam splitter system is configured to mount to a conventional microscope or a conventional surgical microscope.

In embodiments, the beam splitter system of the present disclosure in configured to be mounted to a conventional ocular module and a conventional microscope module. The beam splitting system can include a beam splitter having a pair of spaced apertures arranged along a first axis and a pair of spaced openings that are arranged along a second axis. The respective first and second axis can be positioned in a common view plane such that the respective apertures of the upper surface of the housing are positioned in overlying registration with the respective openings of the lower surface of the housing. Thus, each of the registered aperture/opening defines an optical pathway (extending along an optical pathway longitudinal axis) for light to pass through the respective mount opening, through the inner cavity of the housing, and to exit the respective aperture.

The housing can also define a pair of reflection optical channels. Each reflection optical channel preferably extends from an inner cavity of the housing of the beam splitter to a port of the respective reflection optical channel at a normal angle with respect to the common view plane and at a normal angle with respect to optical pathway longitudinal axis. In this embodiment, a portion of the housing proximate a respective port can be sized or otherwise configured to allow for an image capture system to be mounted thereto.

The beam splitter further includes at least one mirror assembly having a mirror armature and a mirror. Each mirror armature is positioned within the interior cavity of the housing and extends inwardly into a respective optical pathway such that the distal end of the armature is positioned proximate the optical pathway longitudinal axis. A bottom surface of the mirror can be mounted to the distal end of the mirror armature such that a reflective surface of the mirror is oriented at a 45 degree angle with respect to the optical pathway longitudinal axis.

The beam splitter of the present disclosure generates an amount of visual occlusion that is less than 20%. Further, because the light that is passed though the beam splitter to the ocular module does not pass through an interface or glass in the beam splitter, there is no introduction of distortion, aberrations, or visual degradation.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIG. 1 schematically illustrates an example of a conventional surgical microscope with a mounted prior art cube beam splitter module.

FIGS. 2A and 2B schematically show perspective views of a conventional surgical microscope having a beam splitter system of the present disclosure operatively mounted thereto. These images shows the beam splitter system being set up for beam splitting for both a left and the right light beam for conventional binocular views. It is also contemplated that the beam splitter system can also be configured for use with a single light beam (a mono set up).

FIG. 3 shows a perspective view of the beam splitter system, showing two image capture systems being coupled to respective distal ends of a beam splitter body.

FIG. 4 shows a cross-section view of the beam splitter system shown in FIG. 3, showing red arrows indicating the direction of light as it passes through the beam splitter system.

FIG. 5 shows a top elevational view of the beam splitter system of FIG. 3, showing respective left and right mirror assemblies extending partially into the respective defined optical pathways.

FIG. 6 shows a cross-sectional view of FIG. 5, showing a mirror assembly attached to a portion of a wall surface of the defined optical pathway and extending inwardly toward the center of the defined optical pathway, and showing a mirror of the mirror assembly being oriented an acute angle with respect to the longitudinal axis of the optical pathway to reflect a portion of the light beam toward the lens assembly of a coupled image capture system to then be received by the camera of the image capture system.

FIG. 7 shows an end elevational view of the beam splitter system of FIG. 3.

FIG. 8 shows a side elevational view of the beam splitter system of FIG. 3, showing a viewing oculars mount to a top portion of the beam splitter body and a microscope mount on a bottom portion of the beam splitter body.

FIG. 9 shows a schematic image demonstrating an exemplary total occlusion of the optical pathway by the mirror assembly.

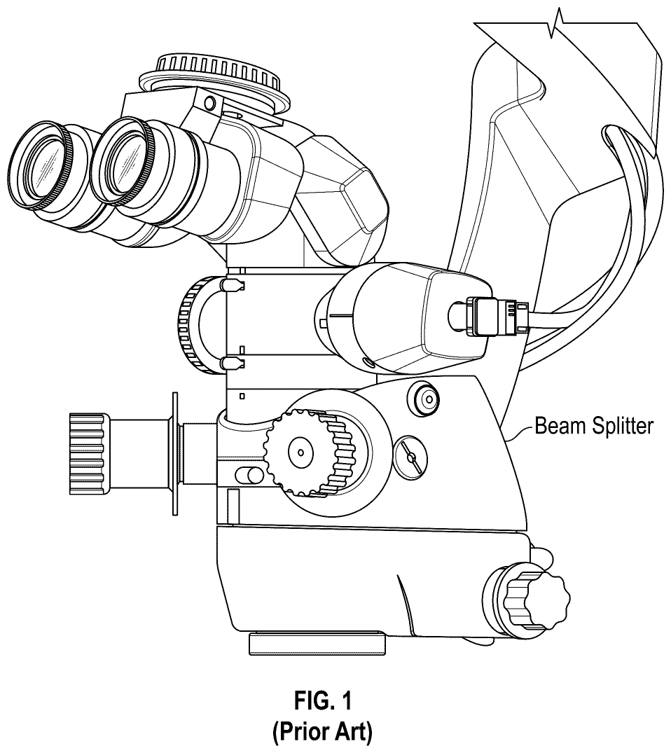

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a port” can include two or more such ports unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

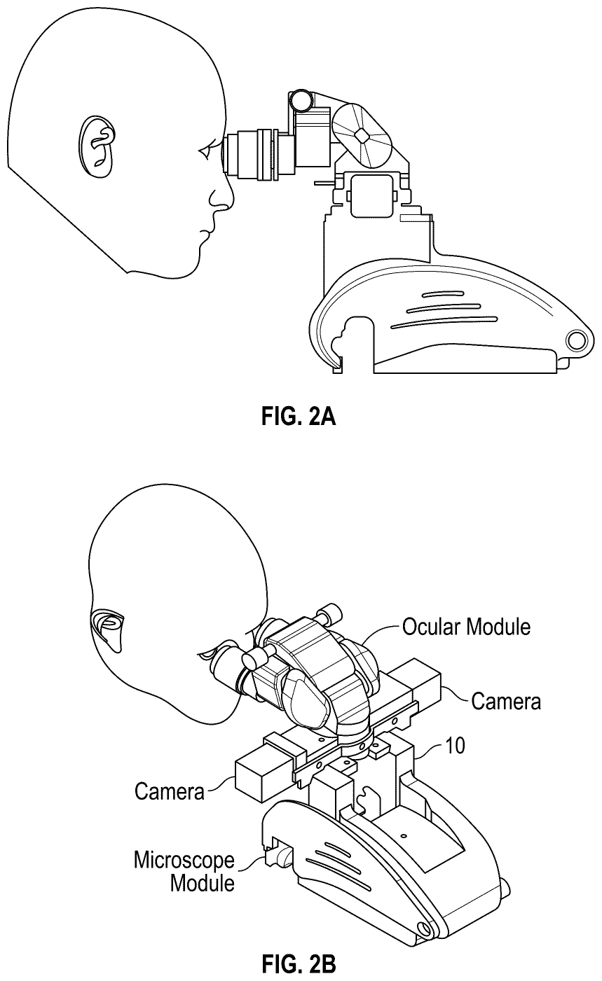

FIGS. 2A and 2B illustrate an example of a microscope system 2 that has a beam splitter system 10 of the present disclosure operatively mounted thereto. This image shows the beam splitter system 10 being set up for beam splitting for both a left and a right light beam for conventional binocular viewing. It is contemplated that the beam splitter can also be configured for use with a single light beam (a mono set up).

In the example, the microscope system 2 can conventionally include an objective lens, one or more eyepieces, one or more ports, and an image system 4. It is contemplated that the conventional microscope system 2 can be in the form of any suitable conventional microscope, such as, for example and without limitation, a surgical ophthalmic optical microscope. As one will appreciate, such an ophthalmic optical microscope conventionally includes one or more lenses that produce an enlarged image of a target placed in the focal plane of the microscope. These lenses conventionally focus light from (e.g., emitted or reflected from) the target towards a detector (such as a user's eye). Commonly, the lenses of such an ophthalmic optical microscope can include an objective lens, which is configured to gather light from the target and focus the light beam to produce a real image.

In embodiments, the beam splitting system 10 can be configured to the target light beam and/or combine the target light bear with another light beam as required. Exemplarily, the beam splitting system 10 can be configured to send at least some light from the target to eyepieces, ports, and/or image system(s). As illustrated, eyepieces are typically located near the focal point of the objective lens to allow an observer to view an image of the target. The microscope ports can be used to couple devices that can receive the target light beam, e.g., one or more additional eyepieces for another observer or an additional image capture system.

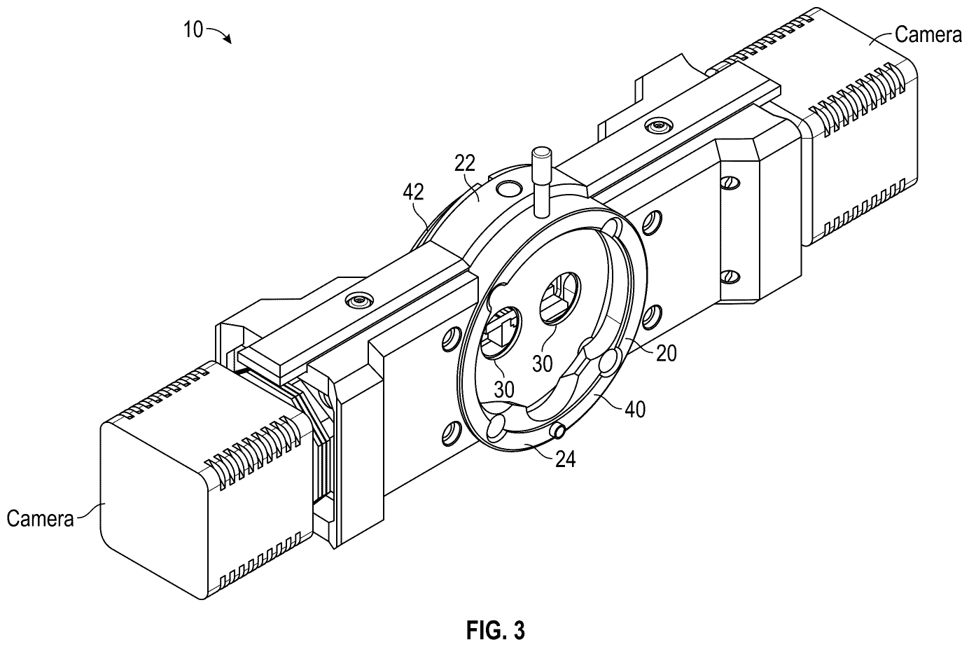

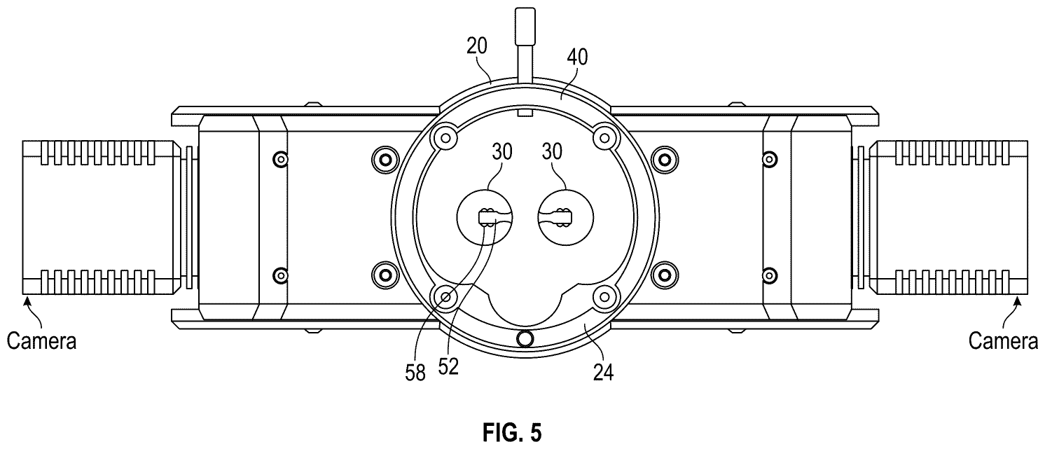

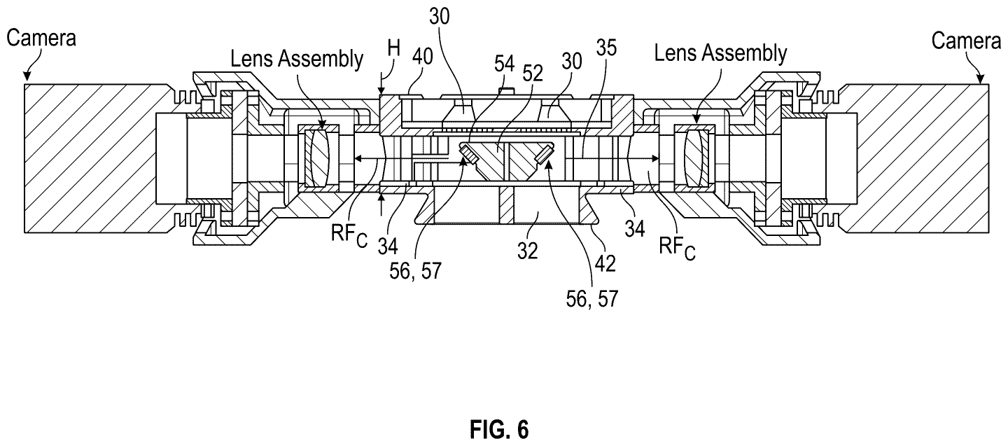

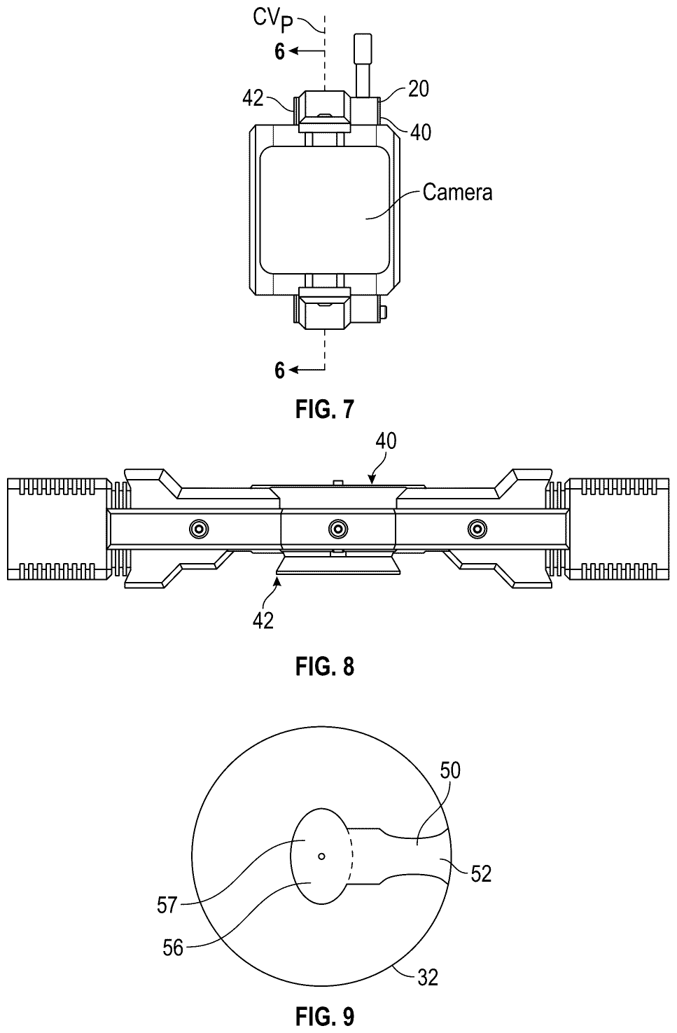

In embodiments, and as schematically illustrated in FIGS. 3-8, the image system 4 can comprise a conventional image capture system that receives light beams from the beam splitter system 10 and generates one or more images (such as a single image or a stream of images) of the target from the light beams. For example, the image capture system may be a conventional video camera that generates video images of the target. In this example, such a conventional image capture system can further include optics and/lenses that form a lens assembly that can be operatively adjusted to ensure the focus of the image that is received by the video camera.

In embodiments, the beam splitting system 10 can include a beam splitter 20 having a housing 22. In embodiments, the beam splitter 20 of the present disclosure is configured to be mounted to conventional ocular and microscope modules. For example, the beam splitter 20 of the present disclosure can be positioned, i.e., mounted, with respect to the ocular and microscope modules as demonstrated in FIG. 2B. Referring to FIG. 2A, the beam splitter 20 of the present disclosure advantageously allows for the beam splitter system 10 to have an operative height (H) that is less than the operative heights of conventional cube beam splitter systems. Using a conventional cube beam splitter systems generally adds at least 50 mm in operative “stack” height of the overall microscope, which can cause discomfort and bad posture for a microscope user. Because the cube prism in a conventional cube beam splitter has to encompass the entire aperture, the cube prism has to be as tall as it is wide-resulting in the undesired increased height of a conventional cube beam splitter.

Additionally, the increased “stack” height of a microscope incorporating a conventional cube beam splitter also disadvantageously increases the distance between user's eye level (at the eyepieces of the ocular module) and the patient focal plane. These disadvantages are addressed in the beam splitter system 10 of the present disclosure, in which the housing 22 of the beam splitter 20 can have a height (H) that is less than 50 mm, preferably less than 40 mm, and more preferably less than 30 mm. In one preferred example, the height (H) for the housing 22 of the beam splitter 20 can be less than 25 mm.

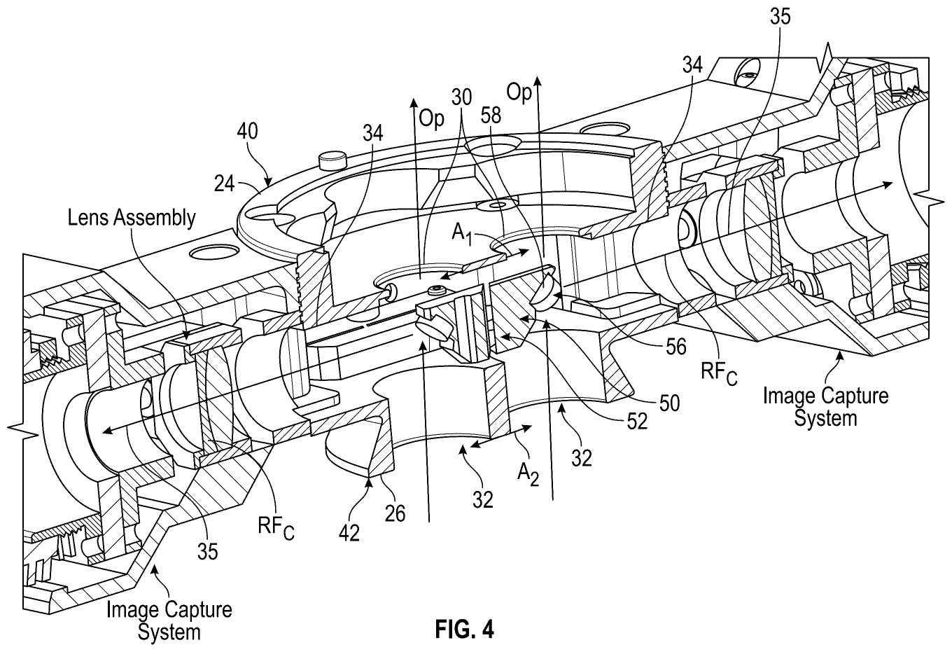

In embodiments, the housing 22 of the beam splitter 20 has an upper surface 24 and a lower surface 26 bounding at least a portion of an inner cavity 28. As exemplarily shown, the upper surface 24 of the housing 22 of the beam splitter defines a pair of spaced mount apertures 30 arranged along a first axis A₁ and the lower surface 26 of the housing 22 defines a pair of spaced mount openings 32 that are arranged along a second axis A₂. As shown in FIG. 4, it is contemplated that the respective first and second axis A₁, A₂ of the respective spaced upper and lower surface 24, 26 can be positioned in a common view plane such that the respective mount apertures 30 of the upper surface 24 of the housing are positioned in overlying registration with the respective mount openings 32 of the lower surface 26 of the housing. Thus, each registered aperture/opening defines an optical pathway Op (extending along an optical pathway longitudinal axis that extends in the common view plane) for light to pass through the respective mount opening, through the inner cavity of the housing, and to exit the respective mount aperture.

As shown, it is contemplated that a portion of the upper surface 24 of the housing surrounding the pair of mount apertures 30 can define an ocular mount 40 that is sized or otherwise configured to allow for a conventional ocular module to be mounted thereto. Similarly, it is contemplated that a portion of the lower surface 26 of the housing surrounding the pair of mount openings 32 can define a microscope mount 42 that is sized or otherwise configured to allow for a conventional microscope module to be mounted thereto.

The housing 22 can also define a pair of ports 34 that are positioned on respective distal ends of the housing. As shown in embodiments, the housing can further define a pair of reflection optical channels RF_{C}. Each reflection optical channel RF_{C} preferably extends from the inner cavity 28 of the housing to the respective port 34 of the respective reflection optical channel RF_{C} along a reflective beam axis 35 that is in the common view plane and is at a normal angle with respect to the optical pathway longitudinal axis of an optical pathway. In this embodiment and as shown, it is contemplated that a portion of the housing 22 proximate a respective port 34 can be sized or otherwise configured to allow for an image capture system to be mounted thereto.

In embodiments and referring to FIGS. 4-6, the beam splitter 20 can further include at least one mirror assembly 50. As exemplified, what is shown is a respective right and left mirror assembly. However, in embodiments, it is contemplated that in a mono beam splitter system, the beam splitter 20 would only use one mirror assembly. As exemplarily shown, each mirror assembly 50 can comprise a mirror armature 52 and a mirror 56. In this aspect, each mirror armature 52 can be positioned within the interior cavity 28 of the housing 22 in the common view plane and can extends inwardly toward a respective optical pathway such that a distal end 54 of the mirror armature 52 can be positioned proximate the optical pathway longitudinal axis of the optical pathway. In embodiments, the mirror armature 52 can be a planer member 54 that can be positioned within the common view plane and can desirably have a minimized width.

In embodiments, the mirror 56 of the mirror assembly has a reflective surface 57 and an opposed bottom surface 58. In this aspect, it is contemplated that the reflective surface 57 is polished and is substantially free from artifacts. In embodiments, the reflective surface of the mirror 56 can have a circular shape, which, as one skilled in the art will appreciate, forms an ellipse shape when viewed from the bottom elevation of the housing 22 through aperture 32 (as exemplarily shown in FIG. 9). In this example, it is contemplated that the diameter of the mirror 56 can be minimized to reduce the effective surface area of the reflective surface. In one example, the diameter of the mirror 56 can be less than 7 mm, preferably less than 6 mm, more preferably less than 5 mm, and still more preferably less than 4 mm (with commensurate surface areas). It is further contemplated that the reflective surface 57 of the mirror 56 could have other geometric shapes, such as, for example and without limitation, a square shape, a rectangular shape, or the like.

In embodiments, the bottom surface 58 of the mirror assembly 50 can be mounted to the distal end 54 of the mirror armature 52 such that the reflective surface 57 of the mirror is oriented at a 45 degree angle with respect to the optical pathway longitudinal axis of the optical pathway. As further illustrated, it is contemplated that the reflective surface 57 of the mirror is positioned in a reflective plane that is positioned at a 45 degree angle with respect to the reflective beam axis of the reflection optical channel. In this position, light impacting the reflective surface 57 can be redirected along the reflective beam axis to pass through a respective reflection optical channel and into the image capture system. In this embodiment, the reflective beam axis is positioned in the common view plane at a right angle to the optical pathway longitudinal axis.

In embodiments, the beam splitter 22 of the present disclosure generates an amount of visual occlusion that is less than 20%. Preferably, and as demonstrated in FIG. 9, the beam splitter 22 of the present disclosure generates a total aperture occlusion that is less than 20%, less than 15%, and more preferably less than 10%. In one exemplary embodiment, the beam splitter 22 of the present disclosure can generate a total aperture occlusion that is about 12%. Further, because the light that is passed though the beam splitter 22 to the ocular module does not pass through an interface or glass in the beam splitter, there is no introduction of distortion, aberrations, or visual degradation. Surprisingly, it was found that at the low levels of total aperture occlusion produced by the beam splitter 22 of the present disclosure, the user does not perceive the presence of the mirror assembly 50.

Accordingly, modifications may be made to the embodiments without departing from the scope of the invention. For example, modifications may be made to the systems and apparatuses disclosed herein. The components of the systems and apparatuses may be integrated or separated, and the operations of the systems and apparatuses may be performed by more, fewer, or other components. As another example, modifications may be made to the methods disclosed herein. The methods may include more, fewer, or other steps, and the steps may be performed in any suitable order.

What is claimed is:

1. A beam splitter system configured to be mounted to an ocular module and a microscope module, comprising:
a beam splitter comprising:
a housing having an upper surface and a lower surface and defining an inner cavity, the upper surface defining a pair of spaced mount apertures arranged along a first axis and the lower surface defining a pair of spaced mount openings arranged along a second axis, wherein the respective first and second axis are positioned in a common view plane such that the respective mount apertures of the housing are positioned in overlying registration with the respective mount openings of the housing and each respective registered mount aperture and mount opening defines an optical pathway that extends along an optical pathway longitudinal axis in the common view plane for light to pass through the respective mount opening, through the inner cavity of the housing, and to exit the respective mount aperture, the housing further defining a pair of ports that are positioned on respective opposing distal ends of the housing and a pair of reflection optical channels extending from the inner cavity of the housing to the respective port of the respective reflection optical channel along a reflective beam axis that is in the common view plane and at a normal angle with respect to the optical pathway longitudinal axis of an optical pathway;
at least one mirror assembly, each mirror assembly comprising:
a mirror armature positioned in the common view plane within the interior cavity of the housing and extending inwardly toward a respective optical pathway such that a distal end of the mirror armature can be positioned proximate the optical pathway longitudinal axis of the optical pathway and
a mirror having a reflective surface and an opposed bottom surface, wherein the bottom surface is mounted to a portion of the distal end of the mirror armature such that the reflective surface of the mirror is oriented at about a 45 degree angle with respect to the optical pathway longitudinal axis of the optical pathway.

2. The beam splitter system of claim 1, wherein the height between the upper surface and the lower surface is less than about 50 mm.

3. The beam splitter system of claim 1, wherein the height between the upper surface and the lower surface is less than about 30 mm.

4. The beam splitter system of claim 1, wherein a portion of the upper surface of the housing surrounding the pair of mount apertures defines an ocular mount that is sized or otherwise configured to allow for the ocular module to be mounted thereto.

5. The beam splitter system of claim 1, wherein a portion of the lower surface of the housing surrounding the pair of mount openings can define a microscope mount that is sized or otherwise configured to allow for the microscope module to be mounted thereto.

6. The beam splitter system of claim 1, wherein a portion of the housing proximate a respective port can be sized or otherwise configured to allow for an image capture system to be mounted thereto.

7. The beam splitter system of claim 1, wherein the planar member of the mirror armature has a minimized width relative to the common view plane.

8. The beam splitter system of claim 1, wherein the reflective surface of the mirror is positioned in a reflective plane that is positioned at a 45 degree angle with respect to the reflective beam axis of the reflection optical channel to redirect light impacting the reflective surface to pass along a reflective beam axis through a respective reflection optical channel and into an image capture system.

9. The beam splitter system of claim 8, wherein the reflective beam axis is positioned in the common view plane at a right angle to the optical pathway longitudinal axis.

10. The beam splitter system of claim 1, wherein the reflective surface of the mirror is polished.

11. The beam splitter system of claim 1, wherein the reflective surface of the mirror is substantially free from artifacts.

12. The beam splitter system of claim 1, wherein reflective surface of the mirror has a circular shape.

13. The beam splitter system of claim 1, wherein a diameter of the mirror is minimized to reduce the effective surface area of the reflective surface, and wherein the diameter of the mirror is less than about 7 mm.

14. The beam splitter system of claim 1, wherein the diameter of the mirror is less than about 4 mm.

15. The beam splitter system of claim 1, wherein the beam splitter generates an amount of visual occlusion that is less than 20%.

16. The beam splitter system of claim 1, wherein the beam splitter generates a total aperture occlusion that is less than 20%.

17. The beam splitter system of claim 1, wherein the beam splitter generates a total aperture occlusion that is less than 15%.

18. A beam splitter configured to be mounted to an ocular module and a microscope module, comprising:
a housing having an upper surface and a lower surface and defining an inner cavity, the upper surface defining a pair of spaced mount apertures and the lower surface defining a pair of spaced mount openings, wherein the respective pair of spaced mount apertures and spaced mount openings are positioned in a common view plane such that the respective mount apertures of the housing are positioned in overlying registration with the respective mount openings of the housing and each respective registered mount aperture and mount opening defines an optical pathway that extends along an optical pathway longitudinal axis for light to pass through the respective mount opening, through the inner cavity of the housing, and to exit the respective mount aperture;
at least one mirror assembly, each mirror assembly comprising:
a mirror armature positioned within the interior cavity of the housing and extending inwardly toward a respective optical pathway such that a distal end of the mirror armature can be positioned proximate the optical pathway longitudinal axis of the optical pathway and a mirror having a reflective surface and an opposed bottom surface,
wherein the bottom surface is mounted to a portion of the distal end of the mirror armature such that the reflective surface of the mirror is oriented at about a 45 degree angle with respect to the optical pathway longitudinal axis of the optical pathway,
wherein the beam splitter generates a total aperture occlusion that is less than 20%.

19. The beam splitter of claim 18, wherein the height between the upper surface and the lower surface is less than about 50 mm.

20. The beam splitter of claim 18, wherein a portion of the upper surface of the housing surrounding the pair of mount apertures defines an ocular mount that is sized or otherwise configured to allow for the ocular module to be mounted thereto, and wherein a portion of the lower surface of the housing surrounding the pair of mount openings can define a microscope mount that is sized or otherwise configured to allow for the microscope module to be mounted thereto.

21. The beam splitter of claim 18, wherein the housing further defines a pair of ports that are positioned on respective opposing distal ends of the housing and further defines a pair of reflection optical channels extending from the inner cavity of the housing to the respective port of the respective reflection optical channel along a reflective beam axis that is in the common view plane and at a normal angle with respect to the optical pathway longitudinal axis of an optical pathway.

22. The beam splitter of claim 21, wherein a portion of the housing proximate a respective port can be sized or otherwise configured to allow for an image capture system to be mounted thereto.

23. The beam splitter of claim 18, wherein the reflective surface of the mirror is positioned in a reflective plane that is positioned at a 45 degree angle with respect to the reflective beam axis of the reflection optical channel to redirect light impacting the reflective surface through a respective reflection optical channel and into an image capture system, and wherein the reflective beam axis is positioned in the common view plane at a right angle to the optical pathway longitudinal axis.

24. The beam splitter of claim 18, wherein a diameter of the mirror is minimized to reduce the effective surface area of the reflective surface, and wherein the diameter of the mirror is less than about 7 mm.
